(19) United States
(12) Patent Application Publication
(10) Pub. No.: US 2023/0119387 A1
(43) Pub. Date: Apr. 20, 2023

(54) DIGITAL STYLE AND DESIGN GENERATOR

(71) Applicant: CREATE 3D GMBH, Reutlingen (DE)

(72) Inventors: Leonard KROPF, Pliezhausen (DE); Florian WIEST, Horb am Neckar (DE)

(21) Appl. No.: 17/968,869

(22) Filed: Oct. 19, 2022

Related U.S. Application Data
(63) Continuation of application No. PCT/DE2021/100371, filed on Apr. 22, 2021.

(30) Foreign Application Priority Data
Apr. 23, 2020 (DE) 10 2020 111 163.0

(51) Int. Cl. G06T 11/00; G06T 19/00; G06T 7/90; G06F 16/438

(52) U.S. Cl. CPC G06T 11/001; G06T 19/006; G06T 7/90; G06F 16/438; G06T 2210/04; G06T 2210/16; G06T 2200/24; G06T 2207/10024; G06T 2207/10016

(57) ABSTRACT

A system, method and program for generating a digital style pattern and/or transferring the style pattern onto digitally available objects, such as interiors, accessories, clothing and similar, or design proposals of multiple objects based on the generated style pattern based on at least one predefined style specification, including the following steps: specifying or inputting at least one item of style information (optical, acoustic, haptic); analysing the style information, in particular in terms of colour distribution; obtaining at least one digital style pattern and/or assigning or transferring the style pattern onto a digitally available object or multiple digitally available objects.

### CROSS-REFERENCE TO RELATED APPLICATIONS

This is a continuation application under 35 USC § 120 of International Application No. PCT/DE2021/100371, filed on Apr. 22, 2021, and claims priority under 35 USC § 119 to German Application No. 10 2020 111 163.0, filed Apr. 23, 2020, the entire disclosures of which are incorporated herein by reference in their entirely.

### TECHNICAL FIELD OF THE INVENTION

The invention relates to a system and method for generating a digital style scheme and/or transferring the style scheme to digitally present objects such as equipment, accessories, clothing and the like, or to provide equipment suggestions for several objects.

The invention further relates to a computer program and to a computer program product.

### DISCUSSION OF THE RELATED ART

Filter methods and filter devices which search and display predetermined objects to users after input of specifications are generally known from the prior art. Such filters are currently not able to recognize a specified style of a user on the basis of third-party data or to specify the latter in the filter. In addition, the displayed results are often unclear and inconsistent.

### SUMMARY OF THE INVENTION

It is an object of the present invention to provide a method for generating a digital style scheme and/or transferring the style scheme to digitally present objects such as equipment, accessories, clothing and the like, or to provide equipment suggestions for several objects on the basis of the generated style scheme on the basis of at least one predetermined style specifications as well as creating a computer program and a computer program product for this. In particular, it is an object to provide an improved method which enables a style specification, on the basis of which suitable solutions are displayed and which finds an optimal solution. It is also an object to provide a corresponding system for this purpose.

These and other objects are achieved by a method, a computer program, and a computer program product as described herein.

Advantageous developments of the invention are specified in the dependent claims or are specified below in connection with the description of the figures.

### BRIEF DESCRIPTION OF THE DRAWINGS

FIG. 1 is a schematic representation of a digital style and design generator in accordance with an exemplary embodiment of the present invention;

FIG. 2 illustrates an example where a painting of a landscape is input and analyzed by the computer system by recognizing objects, shapes, color distribution, etc., to arrive at a style which is then transferred to an article of clothing in accordance with the invention;

FIG. 3 illustrates an example in which a photograph of a room serves as an input;

FIG. 4 represents an example of transferring a style scheme in accordance with a complementary fashion;

FIG. 5 represents transferring a style scheme to multiple articles such as clothing or bicycle based on combined inputs; and

FIG. 6 represents a block diagram of an exemplary computer system for implementing a digital style and design generator in accordance with an exemplary embodiment of the present invention.

### DETAILED DESCRIPTION OF THE INVENTION

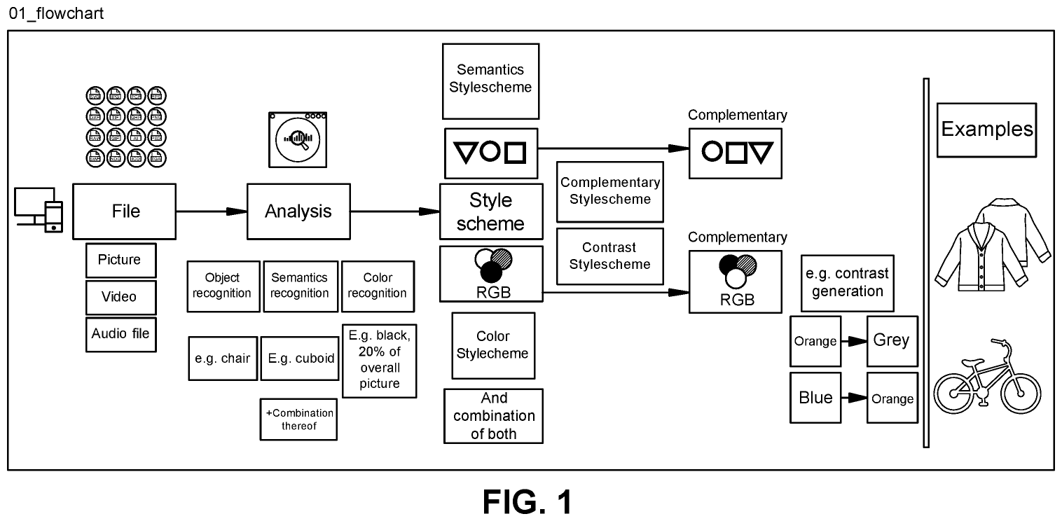

The invention includes the technical teaching that, in a method for generating a digital style scheme and/or transferring the style scheme to digitally present objects such as equipment, accessories, clothing and the like, or of equipment suggestions of several objects on the basis of the generated style scheme, comprising the steps of: Specifying or inputting at least one style information (optic, acoustic, haptic), analyzing the style information, in particular with respect to a color distribution, creating at least one digital style scheme and/or assigning or transferring the style scheme to a digitally present object or several digitally present objects. Referring to FIG. 1, first style information is entered or specified into the computer system implementing the digital style and design generator. This style information may already be present in a database, for example as images on a platform, as a search result of a search engine, as photos taken, as digital pieces of music, as semantic information or the like. This style information is available in digital form or is digitized. In this case, the style information can be present in different formats and is reproduced as optic, haptic, acoustic or other signals or also input. A voice input or the like is also possible. Preferably, style information is specified in the form of a digital image or several digital images. These images include, among others, color information, shape information, object information and the like. In an analysis step, the computer system employs otherwise conventional computer-implemented techniques utilizing image processing, image analysis, object recognition, audio analysis, statistical analysis, etc., on the various inputs. A color distribution can be analyzed from the color information of the image or the images. A shape distribution can be analyzed from the shape information. An object information can be analyzed from the object information. In this case, the color shades, shapes, objects etc. which occur most frequently in the image are determined and a ranking of the occurring colors, shapes, objects, etc. is created. Since there is a plurality of different color shades, shapes, objects, etc., a grouping of color shades, shapes, objects etc. can be made for better evaluation. In this case, the grouping is preferably made in predetermined regions in which, for example, color shades of a color scale are grouped around a most frequent value, for example in the range plus/minus 10 points of the color scale or in a region with a deviation of plus/minus 5%. Similarly, a grouping of shapes, objects, etc. takes place according to specified criteria. For example, a grouping according to angular or round shapes can be carried out. Other or further criteria can also be used for the grouping. The same procedure can be followed with other data. For example, pieces of music can be analyzed and grouped with respect to timbre, tempo, rhythm, pitch and the like. This analysis makes it possible to create style information and style schemes as shown in FIG. 1. In one embodiment, the data are correlated with one another. Thus, for example, a minor key and/or a slow piece of music can be assigned to a dark color scheme, whereas a major key and/or a comparatively faster piece of music is assigned to a rather bright color scheme. This style scheme in the area of colors may be limited to, for example, five different color shades, preferably three different color shades, most frequently occurring in the style information. Since the style information sometimes comprises a lot of information, markers can be used to generate the style information. The number of markers is freely selectable, but is preferably in the range between 1 and 10, preferably 5. For example, the markers can be set via a slide control, wherein the changes in the settings are displayed on a display of the computer system simultaneously in parallel with the adjustment process. The style information, more precisely the style information used to generate the style information, is reproduced to the user including the markers used, preferably graphically, but other representations such as acoustic representation or combinations are also possible. In the reproduction, an interface is provided within the computer system which enables the user to modify the markers. For example, a graphical user interface is provided, which enables a movement of one or more markers on the style information used. Thus, the user may select another piece of information of the style information used, even another style information such as another image, a different video, another piece of music, and the like for the creation of the digital style scheme. The digital style scheme is generated and displayed to fit the selected style information, before, during and/or after a change by a user. Preferably, the style scheme with respect to colors is reduced to less than or equal to 5 colors, preferably to 5 colors. In addition to the digital style scheme generated from the style information, at least one complementary style scheme is displayed. Preferably, a contrast scheme is also displayed. A user can thus select their preferred choice between several preselected style schemes. A scheme takes the style information into account directly. The further style schemes take into account complementary information or further information that is in particular contrary to that derived from the original style information. With regard to colors, the further color style schemes result from the complementary colors or from contrast colors. In a preferred embodiment, the generated style scheme can be reproduced in an augmented reality environment as part of or in addition to the computer system, preferably in real time. In one embodiment, the modification of the criteria is performed continuously, for example with a slide control. In other embodiments, the change in the criteria is grouped or takes place abruptly within predetermined value ranges.

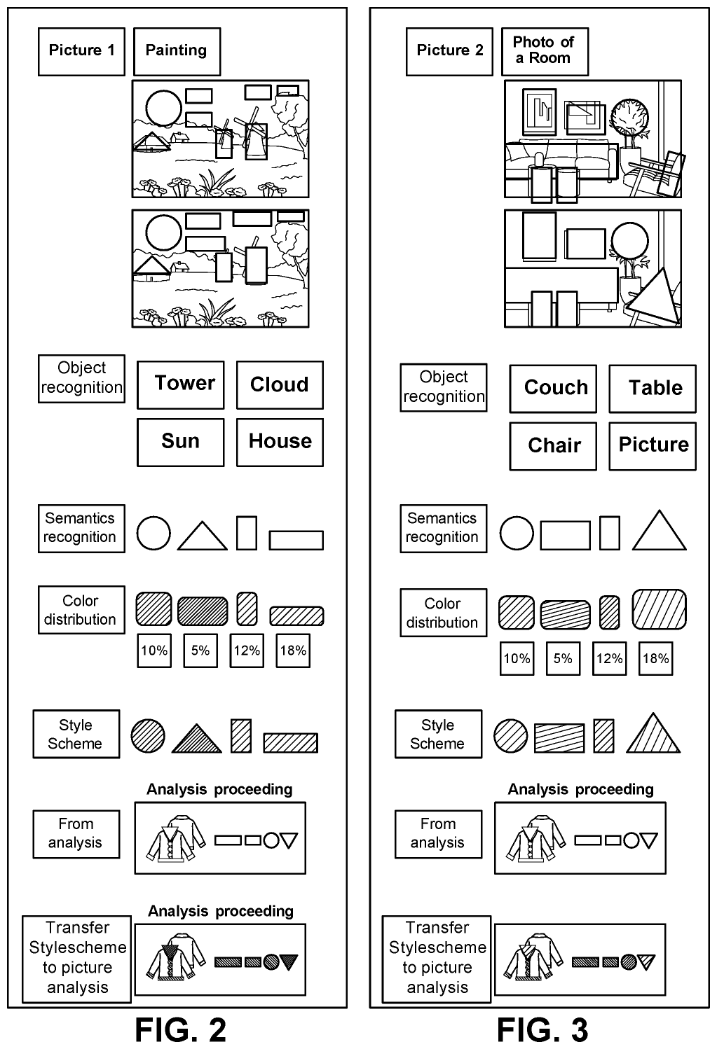

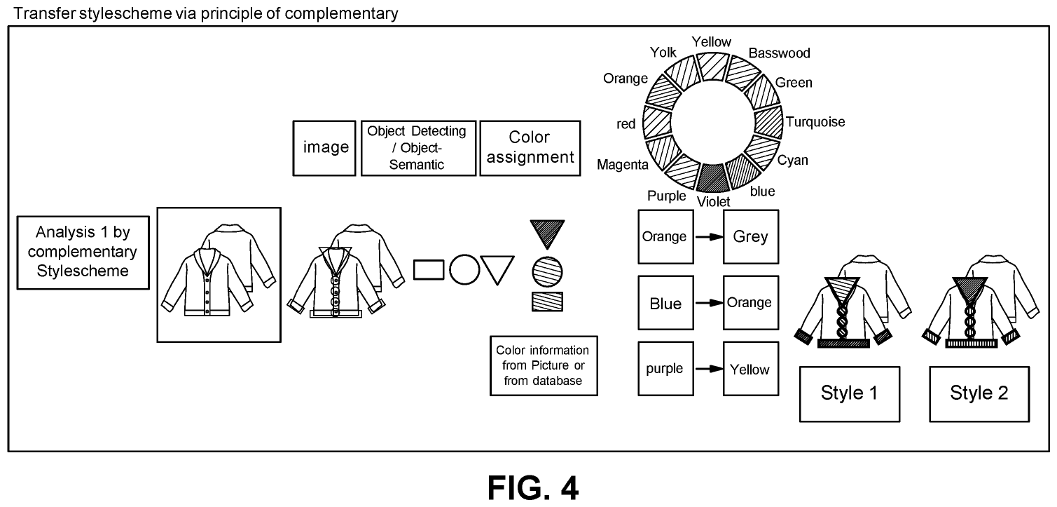

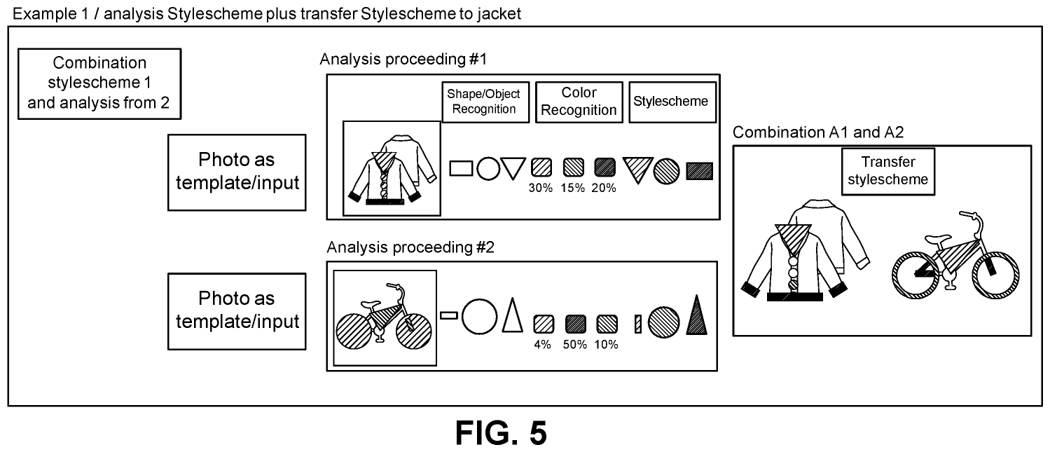

FIG. 2 illustrates an example where a painting of a landscape is input and analyzed by the computer system by recognizing objects, shapes, color distribution, etc., to arrive at a style which is then transferred to an article of clothing in accordance with the invention. FIG. 3 illustrates an example in which a photograph of a room serves as an input. FIG. 4 represents an example of transferring a style scheme in accordance with a complementary fashion. Conversely, FIG. 5 represents transferring a style scheme to multiple articles such as clothing or bicycle based on combined inputs.

Further information can be used to generate a style scheme including further optional style schemes. For example, information about the user can be used, for example age, nationality, gender, skin color, hair color, geodata and the like. The user can enter this data. In one embodiment, these data are detected from the style information, for example by means of facial recognition and the like. Geodata can be obtained in the present case, for example, from the style information, dial-up data into the program, geotrackers or the like. Further information for generating the style scheme can then be used from a database in which preferences or preferred style directions are stored for the personal data. The data can all be correlated and/or stored in a database and retrieved from there.

In one embodiment, the style scheme is displayed without an object, for example as a pure color scheme. In another embodiment, the style scheme can be presented in other types of presentation, for example as a digitally stored object or in other forms. For example, the graphic reproduction is carried out according to the detected color distribution. That is, when color 1 has been detected with 70% frequency, it is displayed in the style scheme at 70%. For example, 70% of the objects can be reproduced in white or also 70% of a single object in white. However, the graphic reproduction can also be reproduced with other color distributions. If, for example, an object is detected in the style information which, for example, has only one color, this can be weighted more sharply and weighted more strongly in the graphic reproduction. Different weighting factors can be employed when the color distribution is detected. Thus, for example, recognized isolated colors can be weighted more strongly. If an object thus has a single color (in certain tolerance ranges of a color scale of plus/minus 5 or 10 percent) and other regions/objects, in particular clearly delimited regions, have several colors, this isolated color can undergo a stronger weighting. The weighting can also be changed by a user. The changes are preferably displayed in real time so that a user immediately experiences an overview of the changes. As a result of the preselection, the user does not have to create a separate new style scheme, but can take over an existing style scheme and merely has to adapt it. A preselection is made from a large number of specifications and a style scheme is generated which is made available to the user. The plurality of specifications is preferably made from a variety of different specifications in different formats (image, music, color, shape, object, . . . ). The user selects an object or an object environment on which he or she wishes to transmit the voice scheme. An object environment adapted to the style scheme is generated from the style scheme and the object environment and displayed to the user. The user can now change criteria and adapt the object environment to the changed criteria.

In a further step, the style scheme is transferred to a digitized object or digitally present objects. These objects can be proposed automatically. In another embodiment, the user specifies the object or objects. In a further embodiment, the object is or the objects are detected from the style information. Yet another embodiment provides that the user selects the objects from a representation of a selection of objects. For example, the style scheme is generated and/or the objects (the object environment) are selected in an augmented reality environment. For example, a style scheme can be specified, and the object environment can be recorded by means of a camera and thus a style-adapted object environment can be displayed. In one embodiment, the object is recognized with respect to its assemblies or areas. In this case, the assemblies or areas are analyzed with respect to their proportions with respect to the overall object. A ranking or a grouping of the proportions takes place. For example, a chair is specified as the object. The chair is grouped into its proportions of the backrest, seat, armrest, frame, frame casters, etc. The proportions of the assemblies with respect to the overall project are determined, for example backrest 50%, armrests 10%, seat 20%, frame 15% and frame casters 5%. This is applied analogously to other objects. The assemblies can be specified by the user, for example through a selection method. A color scheme with 5 colors is assigned to this object according to the color frequencies. In this case, for example, the color is assigned to the largest proportion of the backrest, that is to say the assembly with the largest proportion with respect to the (total) object, and the color with the smallest proportion of the casters and/or the frame, that is to say the assembly with the smallest proportion with respect to the total object, depending on the number of colors and the proportion thereof and depending on the number of assemblies and the proportions thereof with respect to the total object. Thus, the style information is analyzed and grouped proportionally, as well as the object specifications. The style scheme is thus assigned to the object, so that the style scheme can be found on the digital object. This object is reproduced to the user. In addition, in one embodiment, the object is reproduced in another representation/in another model with the complementary style scheme and/or the contrasting style scheme. Other style schemes can be generated also or instead. For example, contrast style schemes could be generated which apply to parameters such as weighting, saturation, distance on a color scale, brightness values, or further composition rules of the color and/or shape gage. For example, a contrast style scheme can be generated in which the colors used differ by at least 10% with respect to saturation, distance on the color scale and/or brightness. For the creation of further contrast style schemes, the percentage value can be regulated as desired, for example 5, 10, 15, 20, 25, 30, 35, 40, 45 or 50 percent distance or difference. The user thus receives a proposal with three objects with different style schemes that apply to the user due to the style specifications. The number of objects can be predefined as desired. For example, the number can be 1 to infinite, wherein a representation can then take place as an endless flow of style schemes with or without assignment to objects. In parallel, the user is shown the style information used together with the markers used. If the user now changes the markers, this change is also shown on the style scheme and the object. Once the user is satisfied with the object, he or she confirms a selection. After confirmation of the object, a search in databases for existing objects can be started on the one hand in order to display available objects to the user. For this purpose, available databases of external providers are accessed, analyzed with respect to the objects with a style assignment, and the database products with the greatest match are displayed. In one embodiment, these objects can be presented with acquisition and/or purchase options. Alternatively or instead, the object information together with the style scheme can be transferred to a manufacturing process of a manufacturer. A corresponding interface is provided for this purpose

In one embodiment, it is provided that the style scheme is predefined in the form of a digital image, several digital images, videos, music files and/or the like. The style information is preferably provided using an image. A color scheme which is used as a style scheme can be generated from this. The image can be recorded as a screen snapshot, for example with a camera, in particular an integrated camera. In other embodiments, an image is uploaded. In yet other embodiments, it is allowed to access images from existing databases or platforms, for example Facebook, Pinterest or other databases. For this purpose, a corresponding interface with access data and/or data converters is provided. The user can limit the selection by input/specification. For example, only sections of images can also be used. For example, it can also be determined that landscape backgrounds remain unconsidered or unrelated persons are hidden in images. The images are thus divided into different areas which can be selected for the analysis. The selection made is used to analyze the style scheme. In this context, a color analysis is preferably carried out. In addition to this color analysis, further information such as personal data, geodata, etc. can also be taken into account. Situations such as sport, work, leisure are also recognized, so that they can be taken into account in the case of an object selection (object selection, object deletion, . . . ).

In a further embodiment, it is provided that the data entered or the data that are read out from databases are analyzed together and a few, in particular three, preferably one style scheme is created therefrom. The totality of style information from the specified data is reduced or compressed to a style scheme. In this case, the data are weighted or sorted according to their respective proportion. By setting markers, the user can prefer and thus weight certain areas for generating the style scheme. The selection marked with the markers is weighted and taken into account in the style scheme analysis. This can be performed iteratively until the user agrees with the selection made.

Yet another embodiment provides that at least one complementary style scheme and/or another contrast scheme deviating from the identified style scheme is created in addition to the generated style scheme or to the generated style schemes. A complementary style scheme is created for the identified style scheme. In the case of colors, this has the complementary colors. In addition, a contrast scheme is created. This has contrast colors in the colors. Other generation rules from the color and/or shape gage are conceivable. Thus, for example, a contrast style scheme is generated by means of the following rules: monochromatic generation, analogous generation, triadic generation, complementary generation, split complementary generation, tetratic generation and/or other generations as well as combinations thereof. The generation can also be specified by manual specifications of the user. In one embodiment, the same generation method is used for all objects. In another embodiment, different generation methods are used at least for two, in particular two different objects. The application of the generation method can be selected using the object category so that the same generation method is applied for objects of the same object category, but another generation method is applied for objects of another object category.

In another embodiment, it is provided that a portion of the style information is generated and/or specified, which is used for the analysis of the style information. In one embodiment, the style information is analyzed in areas such as background, foreground, person, face, objects. Other regions may be the center of the image, the image edge. The user can specify which areas are used for the style scheme analysis and can change them. Preferably, the analysis is carried out in a first step without intervention by the user, thus objectively based on the determined frequencies of certain style information. Thus, in one embodiment, the image center or the information present therein is weighted more strongly than, for example, the image edge. The raw style information, that is, the style information that is available from the specifications before compressing into a style scheme will be displayed to the user. Here, the user or a system can weight the present information and thus influence the style scheme to be generated. The weighting can take place in several steps. Preferably, the raw style data and the compressed style scheme, optionally together with the style scheme transferred to an object environment, are reproduced to the user in parallel, simultaneously and/or next to each other, preferably on a monitor and/or through a loudspeaker.

An embodiment also provides that the object is specified by means of the style information, by means of assignment from a database and/or by specification by a user, and then the assignment of the generated style scheme to the object takes place, in particular the color scheme. The color scheme can be transferred to the object according to the color components. In a further embodiment, a texture is also assigned to the digital object. The style schemes are taken into account. In one embodiment, real textures, for example surface structures, materials and material properties are stored. The selection of the texture or the assignment only takes place after a check whether the proposal is present in the stored data. If the texture is present, it is adopted. If it is not present, a texture closest to the determined texture is adopted from the stored data.

In another exemplary embodiment, the style information of an object is detected and/or read and stored. The recognition of the style information of the objects takes place analogously to the recognition of the style information of the user. The style information of the object is stored in a database and can be retrieved if necessary.

Thus, in one embodiment, it is provided that a texture is assigned to the object in addition to a color scheme. In addition to textures, further information can be assigned, for example brightness, intensity, etc.

In a further embodiment, it is provided that a search is made in a further database according to objects corresponding to the object assigned to the digital style scheme and/or similar objects, and the search result is displayed. After assignment of the style scheme, the appropriate object with the corresponding style scheme is displayed to the user. Furthermore, a complementary object and a contrast object are displayed. By changing the markers with respect to the style information, the user can make an adjustment of the style scheme, which is then displayed as a result. After the object has been displayed with the associated style scheme, the user can choose whether he or she wishes to display already existing objects from an existing database which correspond to the displayed object or are as close as possible to the object displayed. For this purpose, known databases and search engines are accessed and the required information is transmitted. The data is converted and/or otherwise prepared, before the style scheme is applied. The result is displayed to the user, who can then make a selection. If there is no matching result or if the user wants an own production, the data are transferred to a production process. For this purpose, the data required by a manufacturer are transmitted to the user. For this purpose, a corresponding interface is provided which transmits the corresponding data. Subscriber manufacturers are stored in a database, as well as the required information, for example, so that an automated data exchange including order data takes place. In one embodiment, possible object or range information is also detected by moving the marker. If the marker is set to light green clothing in a style information image and the marker is, for example, placed on a dark green shoe, not only is the different color is recognized, but the further information about the detected object is detected and utilized in the analysis and generation. Thus, a recurring pattern (for example several images with dark green shoes) is recognized and this is taken into account more strongly in the assignment of the generated style scheme with respect to the object shoe. In addition to the color information, object information and/or further range information and the information about the recognized objects is thus also detected by the movement. The size of a marker can vary. Accordingly, the marker can point to individual pixels or to larger areas with several pixels. The system and/or the method is designed as a self-learning method. Thus, after assignment to a user, the method can use previous results as raw style data and process/store changes/adaptations accordingly for later executions of the method. The style data is assigned to a user who must identify himself or herself correspondingly when executing the method. The result (the style scheme) is assigned to the user once he or she has identified themselves.

Thus, it is also provided in one embodiment that the digital data of the object assigned to the style scheme are transmitted to a manufacturing process in order to produce a corresponding object.

The invention also includes the technical teaching that a computer program is provided, comprising program code means for performing all the steps described above when the program is executed on a computer, in particular on a tablet computer or a smartphone. The method can be implemented, for example, as a website, web page application, app, plug-in or other software.

Finally, the invention includes the technical teaching that a computer program product is provided, comprising program code means which are stored on a computer-readable medium and/or can be retrieved via a computer-readable medium in order to carry out the method described above when the program runs in a computer, in particular in a tablet computer or a smartphone.

The method can provide that the style information is interpreted into a semantic variable of a semantic database, such that word information is generated from the style information according to a predetermined vocabulary of a predetermined database. The word information can comprise, for example, classic, work, leisure, elegant, sportive, casual, festive, modern, vintage or the like.

Furthermore, the semantic variable can be linked to the raw object information. The raw object information is the digital information about the object to which the style scheme is assigned without a certain style, i.e., for example, without colors, texture and the like.

In one embodiment, a group of raw objects from a raw object database is selected using the semantic link. For example, clothing, equipment can be assigned or preselected according to the style information.

Another embodiment provides a linking of the semantic variable with material information. The material information can comprise, for example, textile, leather, steel, metal, plastic and the like. A group of materials from a material database can also be selected using the semantic link. Thus, available materials can be stored in a database. In this way, a restriction can take place during a search for existing objects. Preferably, the selection of the group of raw objects with the group of materials is linked to a group of objects. This results in a real image of the object with a style scheme. The objects are depicted, preferably in a selection. After depicting the selection, an object is defined from the group of objects depicted.

In one embodiment, provision is made for a generation of further semantically matching objects for an equipment proposal as well as for a display of the equipment proposal. Thus, for example, after selection of a desk as an object, a generation can take place to the effect that desk utensils, desk chairs, office devices in the appropriate style scheme are displayed. These can be displayed from a database with existing objects or can be displayed as objects to be newly produced.

Thus, in the method in one embodiment, prior to linking the selection of the group of raw objects to the group of materials, a depiction of the raw objects is performed.

In a further embodiment, a depiction of the materials takes place prior to linking the selection of the group of raw objects to the group of materials.

Furthermore, one embodiment provides that the raw objects and/or the materials are depicted again after or along with the depiction of the equipment proposal.

In one embodiment, it is also provided that, after or along with the renewed depiction of the raw objects and/or the materials, these are determined anew, and a generation of semantically matching further objects to a further equipment proposal and a depiction of the equipment proposal are carried out once again.

It is also provided that the specification or input of style information is carried out by means of an upload or by means of a recording of the style information.

In principle, all objects can be considered as objects or object environment for performing the method. Preferred object environments are the object environment of fashion including clothing, head coverings and shoes, furniture, both in the living area and in the working environment, life-style products, in particular also mobile phones and accessories for them, vehicles, including interior and exterior equipment, consumer products and the like.

Preferably, a specification from the object environment to which the generated style scheme is to be applied is generated for the style generation. In one embodiment, the style is generated from an object environment which does not correspond to the object environment to which the generated style scheme is to be applied. Thus, in one embodiment, it is provided that, for example, a style scheme from an apartment is applied to the style scheme for a motor vehicle. In particular, several items of style information from different object environments can be used for generating the style scheme. Thus, for example, the style scheme can be applied to an interior design in which the style scheme is produced from object environments which do not relate to an interior design, but, for example, to clothing, vehicles, life-style products, holiday destinations and preferred pieces of music. Here, for example, it is also possible to resort to pre-evaluated objects such as playlists (for pieces of music), preferred photos, photos uploaded to social media channels or posts. Thus, the style information is obtained from pre-evaluated raw style information.

Further measures improving the invention are specified in the dependent claims or emerge from the following description of an exemplary embodiment of the invention. All of the features and/or advantages arising from the claims, the description or the drawing, including structural details, spatial arrangement and method steps can be essential to the invention both per se and in a wide variety of combinations and can be combined in any composition.

A preferred embodiment is provided in the area of furniture and, for example, chairs. The user uploads style information or allows access to specified style information. The style information is preferably digital images. The digital images can generally relate to chairs or furniture, but can also relate to clothing of the user or other object environments. A color analysis takes place on the basis of the specified style information. The frequency of the colors is evaluated on the digital image and the most frequently occurring colors are selected. Here, the three, five or more, preferably five, most frequently occurring colors are selected. These colors are depicted with the help of markers on the used style information, the digital image. These markers can be changed by the user so that they have a different position with other color information/style information. In addition, a depiction of the three most frequent colors is carried out weighted according to the proportion of the total occurrence. The user is given the possibility of changing the color selection by moving the markers to other positions on the style information, i.e. the digital image, used. The color selection, which represents the style scheme, is changed accordingly. The color selection is transferred to an object or an object environment, in this case a chair, corresponding to the color components, that is to say corresponding to the style scheme. Here, the style scheme comprises the five most frequent colors and their proportion or relation to one another. The number of colors that are to be transferred can be changed by the user. If the information is not already present, the object is divided into different regions or assemblies such as armrest, seat, backrest, frame. In this case, the proportions or relations of the assemblies to each other are defined, determined or already specified. For example, a style scheme results in a color distribution of black 60%, orange 25% and green 15%. The areas of the chair result in 40% backrest, 20% seat, 20% armrest and 10% frame. The areas can be set or changed. Thus, for example, the result of matching those proportions would result in an assignment of the backrest and the frame to black, the seat to orange and armrest to green. In addition to this assignment, an assignment with a complementary style scheme and a contrast style scheme is also displayed to the user. The user can choose from this selection and still change the style scheme by changing the mark on the image. As soon as the user has specified an object with a corresponding style scheme, he or she can choose to have those objects displayed from a database with existing objects which are closest to the object being determined with the associated style scheme. Platforms, databases, search engines, etc. can be used for this purpose. An interface ensures the transfer of the corresponding data and setting the corresponding filters. If no object is present which corresponds to the user's wishes, the data can be transferred to a manufacturing process of a manufacturer. A manufacturer is stored here. A corresponding interface is provided which transfers the production data, including order data, to the manufacturer. The manufacturer provides information on price, delivery time, etc. In addition, the user receives, optionally on request, further objects that might fit the selected object in the respective style scheme. The style scheme is transferred onto the further objects accordingly. In this case, not only are the assemblies of the respective objects taken into account, but also the proportions of the objects with respect to the entirety of the objects. For example, if a conference chair is selected, further objects for a conference room are displayed to the user. In an example, this includes 8 conference chairs and a conference table as well as a side board. The conference table occupies, for example, 50%, the chairs 40% and the side board 10% of the total proportion. Other distribution algorithms are applicable. Thus, a distribution can take place manually or randomly or according to typically provided object patterns, which are stored accordingly. Accordingly, the style scheme is transferred to the entirety of the objects. In this case, the style scheme can then also be found in the individual objects, but an assignment to the entirety of objects is primarily determined. After a graphic representation of the object or objects with the style scheme, the data can be processed for an augmented reality representation. In this case, an actual situation is detected and/or displayed by means of a camera, for example, and the selected objects are displayed in the actual situation, preferably as 3D objects. In this way, the user can, for example, display the empty conference room and have the selected objects in the conference room displayed using augmented reality representation. The representation changes according to the perspective of the empty conference room.

In one embodiment of the present invention, all method steps can be carried out completely by general means for data processing. These means can be implemented in a PC, a smartphone, a tablet computer or the like. Thus, it is provided in one embodiment that a computer-implemented method is provided, comprising at least one of the steps described here, in particular the steps of specifying or inputting at least one style information (optic, acoustic, haptic), analyzing the style information, in particular with respect to a color distribution, creating at least one digital style scheme and/or assigning or transferring the style scheme to a digitally present object or several digitally present objects.

In other words, in one embodiment, a method executed by a computer is provided, comprising the steps described here, in particular the steps of specifying or inputting at least one style information (optic, acoustic, haptic), analyzing the style information, in particular with respect to a color distribution, creating at least one digital style scheme and/or assigning or transferring the style scheme to a digitally present object or several digitally present objects.

In one embodiment, the present invention can be implemented on a corresponding device or a corresponding system. Therefore, a device or a system for data processing is provided that includes means for performing the steps described here of the method described here. In particular, a device or a system for data processing is provided, comprising at least one processor, which is adapted or configured such that it executes the method described here or the steps of the method described here.

Furthermore, a computer program product is also provided, comprising instructions which, when the program is executed by a computer, cause the computer to execute the method described here or the steps of the method described here.

In addition, a non-transient computer-readable (storage) medium or a computer-readable data carrier is provided, comprising commands which, when executed by a computer, cause the latter to execute the method described here or the steps of the method described here. A computer-readable data carrier is thus provided, on which the computer program product described here is stored. In particular, a data carrier signal is also provided which transfers the computer program product described here.

The method described here or the steps of the method described here can also be realized in a distributed computer environment. This computer environment provides at least one transmission device, comprising means for encoding data by at least partial execution of the steps of the method described here as well as means for transmitting the encoded data to a receiving device.

Accordingly, a receiving device is provided, comprising means for receiving encoded data from a transmission device, in particular the transmission device described here, and means for decoding the data for execution of at least some of the steps described here of the method described here.

Furthermore, a system is provided, comprising a transmission device described here and a receiving device described here.

For the implementation of the invention in a distributed computer environment, a computer program (product) is provided, comprising instructions which, when the program is executed by a first computer, cause the latter to encode data by executing at least one of the steps described here, and to send the encoded data to a second computer.

Furthermore, a computer program (product) is provided, comprising instructions which, when the program is executed by a second computer, cause the latter to receive, by executing at least one of the steps described here, data encoded by a first computer and to decode the received data.

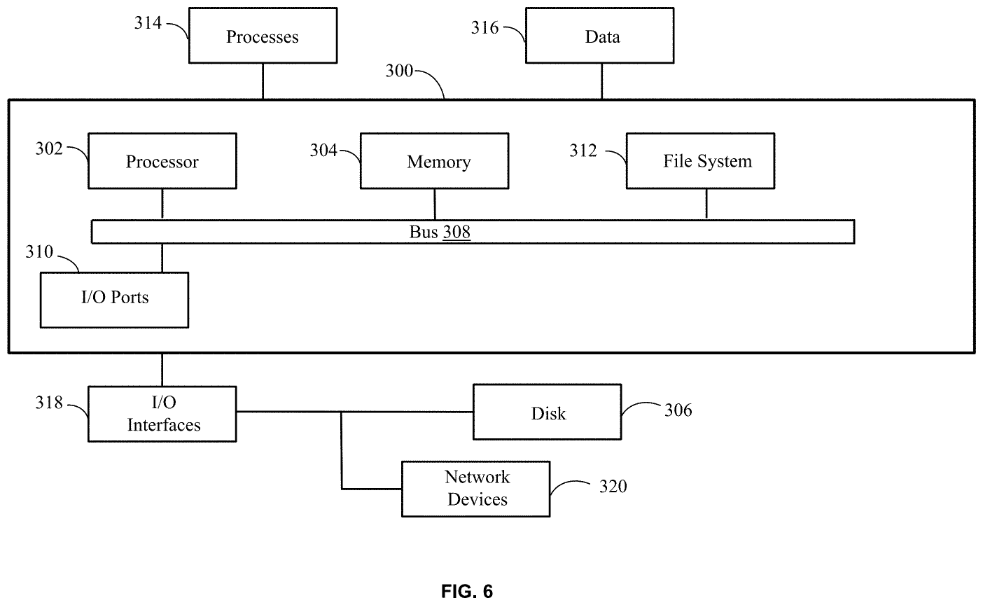

FIG. 6 illustrates a block diagram of an exemplary computer system 300 for implementing a digital style and design generator in accordance with the invention described herein. The system 300 may include a processor 302, a memory 304, I/O Ports 310, and a file system 312 operably connected by a bus 308.

In one example, the system 300 may transmit input and output signals via, for example, I/O Ports 310 or I/O Interfaces 318 of the types described herein. Thus, the digital style and design generator, and its associated components, may be implemented in the computer system 300 as hardware, firmware, software, or combinations thereof and, thus, the system 300 and its components may provide means for performing functions described herein as performed by the digital style and design generator and its associated components as described herein.

The processor 302 can be a variety of various processors including dual microprocessor and other multi-processor architectures. The memory 304 can include volatile memory or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 306 may be operably connected to the system 300 via, for example, an I/O Interfaces (e.g., card, device) 318 and an I/O Ports 310. The disk 306 can include, but is not limited to, devices like a magnetic disk drive, a solid state disk drive, a floppy disk drive, a tape drive, a Zip drive, a flash memory card, or a memory stick. Furthermore, the disk 306 can include optical drives like a CD-ROM, a CD recordable drive (CD-R drive), a CD rewriteable drive (CD-RW drive), or a digital video ROM drive (DVD ROM). The memory 304 can store a computer program which, when executed by the processor 302, cause the system to carry out the functions described herein. The disk 306 or memory 304 can store an operating system that controls and allocates resources of the system 300.

The bus 308 can be a single internal bus interconnect architecture or other bus or mesh architectures. While a single bus is illustrated, it is to be appreciated that system 300 may communicate with various devices, logics, and peripherals using other busses that are not illustrated (e.g., PCIE, SATA, Infiniband, 1394, USB, Ethernet). The bus 308 can be of a variety of types including, but not limited to, a memory bus or memory controller, a peripheral bus or external bus, a crossbar switch, or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial (USB) bus, and a small computer systems interface (SCSI) bus.

The system 300 may interact with input/output devices via I/O Interfaces 318 and I/O Ports 310. Input/output devices can include, but are not limited to, a keyboard, a microphone, a pointing and selection device, cameras, video cards, displays, disk 306, network devices 320, and the like as described herein. The I/O Ports 310 can include but are not limited to, serial ports, parallel ports, and USB ports.

The system 300 can operate in a network environment and thus may be connected to network devices 320 via the I/O Interfaces 318, or the I/O Ports 310. Through the network devices 320, the system 300 may interact with a network. Through the network, the system 300 may be logically connected to remote devices. The networks with which the system 300 may interact include, but are not limited to, a local area network (LAN), a wide area network (WAN), and other networks. The network devices 320 can connect to LAN technologies including, but not limited to, fiber distributed data interface (FDDI), copper distributed data interface (CDDI), Ethernet (IEEE 302.3), token ring (IEEE 302.5), wireless computer communication (IEEE 302.11), Bluetooth (IEEE 302.15.1), Zigbee (IEEE 302.15.4) and the like. Similarly, the network devices 320 can connect to WAN technologies including, but not limited to, point to point links, circuit switching networks like integrated services digital networks (ISDN), packet switching networks, and digital subscriber lines (DSL). While individual network types are described, it is to be appreciated that communications via, over, or through a network may include combinations and mixtures of communications.

It is understood that the above-mentioned features of the invention can be used not only in the respectively specified combination but also in other combinations or alone without departing from the scope of the invention.

1. An automated method for generating a digital style scheme and/or transferring the style scheme to digitally present objects such as equipment, accessories, clothing and the like, or for providing equipment suggestions for several objects on the basis of the generated style scheme on the basis of at least one predetermined style specification, comprising the steps of:
specifying or inputting at least one style information,
analyzing the style information with respect to a color distribution,
creating, based on the analyzing, at least one digital style scheme and/or
assigning or transferring the style scheme to a digitally present object or several digitally present objects.

2. The method in accordance with claim 1, wherein
the style information is specified in the form of a digital image, several digital images, videos, or music files.

3. The method in accordance with claim 1, wherein
the input data are analyzed together and a few, in particular three, preferably one style scheme is created therefrom.

4. The method in accordance with claim 1, wherein
at least one complementary style scheme and/or another contrast style scheme deviating from the generated style scheme is created to the generated style scheme or to the generated style schemes.

5. The method in accordance with claim 1, wherein
a portion of the style scheme is generated and/or specified that is used to analyze the style information.

6. The method according to claim 1, wherein
the object is specified by means of the style information, by means of assignment from a database and/or by specification by a user, and then the assignment of the generated style scheme to the object takes place, in particular of the color scheme.

7. The method in accordance with claim 1, wherein
in addition to a color scheme, a texture is assigned to the object.

8. The method in accordance with claim 1, wherein
in a further database, a search is performed for objects corresponding to the object associated with the digital style scheme and/or similar objects and the search result is displayed.

9. The method in accordance with claim 1, wherein
the digital data of the object associated with the style scheme are transferred to a manufacturing process in order to produce a corresponding object.

10. The method in accordance with claim 1, wherein
an augmented reality object is generated from the object with the associated style scheme, which object is shown in a digital image as a 3D object or is superimposed thereon.

11. A non-transitory, computer-readable medium having stored thereon a program which, when executed by a computer, causes the computer to carry out the method according to claim 1.

12. A digital style and design generator system for generating a digital style scheme and/or transferring the style scheme to digitally present objects such as equipment, accessories, clothing and the like, or for providing equipment suggestions for several objects on the basis of the generated style scheme on the basis of at least one predetermined style specification, comprising:
a user interface for receiving at least one style information as an input from a user;
a processor configured to analyze the style information with respect to a color distribution, and based on the analysis create at least one digital style scheme and/or assign or transfer the style scheme to a digitally present object or several digitally present objects, and
an output device which presents to the user the created at least one digital style scheme and/or assigned or transferred style scheme to the digitally present object or several digitally present objects.

13. The system in accordance with claim 12, wherein
the style information is input via the user interface in the form of a digital image, several digital images, videos, or music files.

14. The system in accordance with claim 12, wherein
the processor creates at least one complementary style scheme and/or another contrast style scheme deviating from the generated style scheme to the generated style scheme or to the generated style schemes.

15. The system according to claim 12, wherein
the object is specified by means of the style information, by means of assignment from a database and/or by specification by a user, and then the assignment of the generated style scheme to the object takes place, in particular of the color scheme.

16. The system in accordance with claim 12, wherein
in addition to a color scheme, a texture is assigned to the object.

17. The system in accordance with claim 12,
comprising a database, in which the processor performs a search for objects corresponding to the object associated with the digital style scheme and/or similar objects and the search result are displayed via the output device.

18. The system in accordance with claim 12, wherein the processor is configured to transfer the digital data of the object associated with the style scheme to a manufacturing process in order to produce a corresponding object.

19. The system in accordance with claim 12, wherein
an augmented reality object is generated from the object with the associated style scheme, which object is shown in a digital image as a 3D object or is superimposed thereon by the output device.
